(19) United States
(12) Patent Application Publication
(10) Pub. No.: US 2003/0068399 A1
(43) Pub. Date: Apr. 10, 2003

(54) Paper scorer system

(76) Inventor: Michael George Vass, Moorhead, MN (US)

Correspondence Address: MICHAEL G. VASS, Apt # 107, 1203 S. 34th St Cir, Moorhead, MN, 56560, US

(21) Appl. No.: 10/236,639

(22) Filed: Sep. 6, 2002

Related U.S. Application Data
(60) Provisional application No. 60/318,230, filed on Sep. 7, 2001.

(51) Int. Cl. B29C 59/00

(52) U.S. Cl. 425/385

(57) ABSTRACT

A scoring system consisting of a die base and one or more dies. The die base consisting of a soft material and is recessed to accept one or more of the dies as needed. Each die is consisted of scorers arranged in a way to score material accurately.

### CROSS-REFERENCE TO RELATED APPLICATIONS

This application is entitled to the benefit of Provisional Patent Application Ser. No. 60/318,230 file Sep. 7, 2001

### BACKGROUND—FIELD OF THE INVENTION

This invention relates to origami, specifically to folding origami.

### BACKGROUND—DESCRIPTION OF PRIOR ART

Origami has been around ever since paper was created in the Far East.

Origami first consisted of simple folds, but as years past and with the knowledge of origami around the world the folds became more complex.

When folding paper there are preliminary folds that must be folded in order to achieve specific folds. This would discourage someone to fold and sometimes would not achieve a desired result. There are numerous types of scorers which are found in the prior art but none are used in the creation of origami, and none that can score with such accuracy. Web presses with scorers have a problem of paper shrinking and do not score paper in a complex way. Other scoring systems also do not score in a complex way as to create origami.

### SUMMARY

In accordance with the present invention a die consisting of scorers arranged in a way to provide the required scoring. A base that is designed to receive a die and consisting of a soft material.

### OBJECTS AND ADVANTAGES

Several objects and advantages of the present invention are

(a) to provide a scorer to score paper accurately;

(b) to provide a scorer in which the scorers do not pierce the material;

(c) to provide a scorer to score material which eliminates preliminary folds;

(d) to provide a scorer whose scorers can be made of any material to score such material presented;

### DRAWING FIGURES

FIG. 1 shows the complete process.

FIG. 2 shows an example of a finished product using such process.

FIG. 3 shows one of the dies used in scoring the material to create mountain folds.

FIG. 4 shows another die used in scoring the material to create valley folds.

FIG. 5 shows the layout of every mountain and valley fold on material.

FIG. 6 shows a valley fold.

FIG. 7 shows a mountain fold.

### REFERENCE NUMERALS IN DRAWING

10 complete die

11 die base

12 flexible material

13 soft material

14 main base

15 scorers

15 scorers

16 valley fold

17 mountain fold

18 recess in main base

### DESCRIPTION

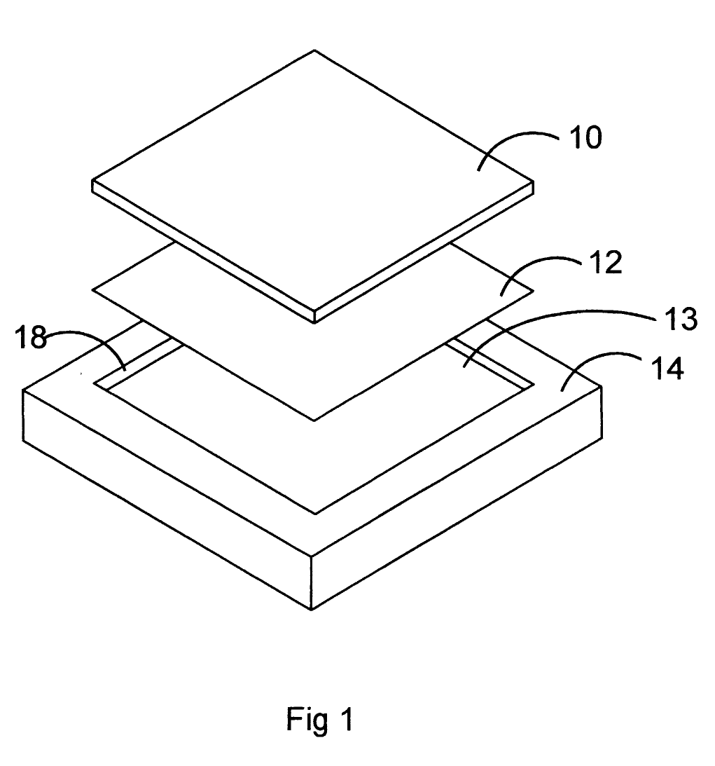

FIG. 1 shows a perspective view of a basic version of my paper scorer system. It consist of a main base 14, a soft material 13 in the recess 18 part of the main base and one or more dies 10. It can be placed ion a machine press or used by hand. The base 14 is consisted of a solid material of any shape or size able to withstand the pressure of the die 10. The base is recessed 18 to allow each die 10 to fit in exactly. Inside the recess 18 section of the base 14 lays a soft material 13. The flexible material 13 lies between the main base 14 and the die 10.

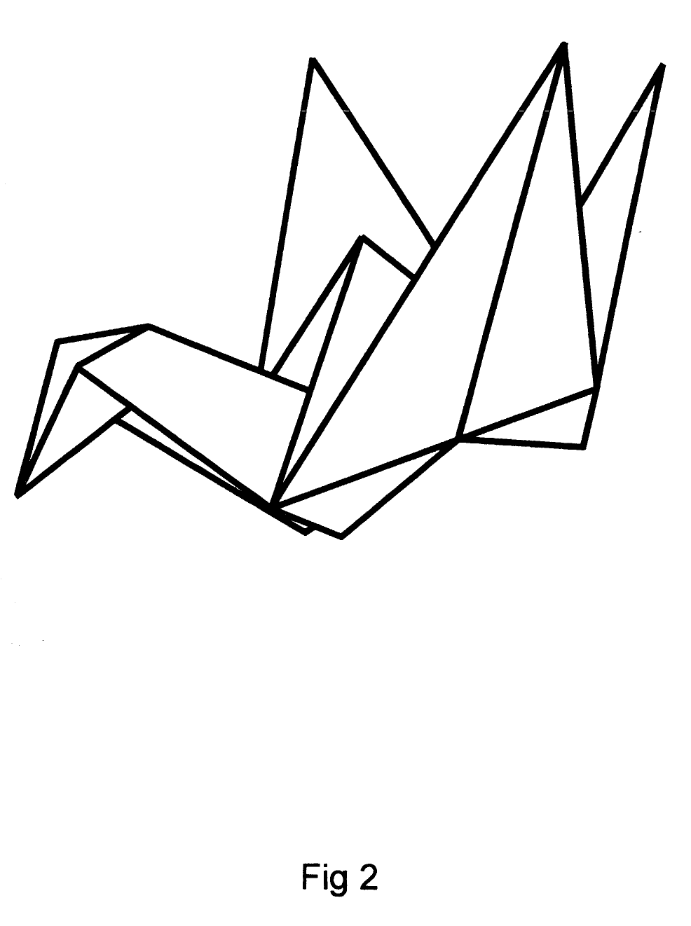

FIG. 2 shows an example of what can be created using this process.

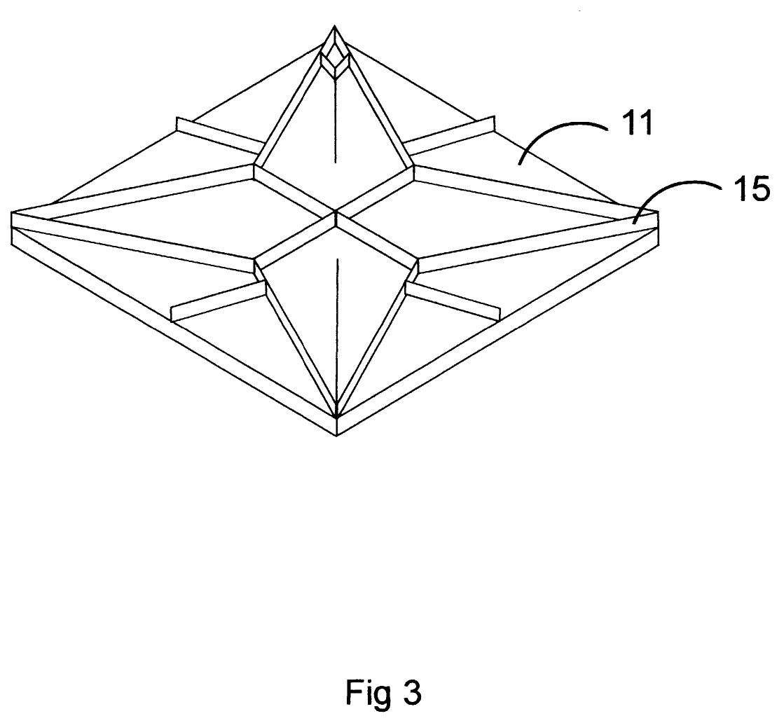

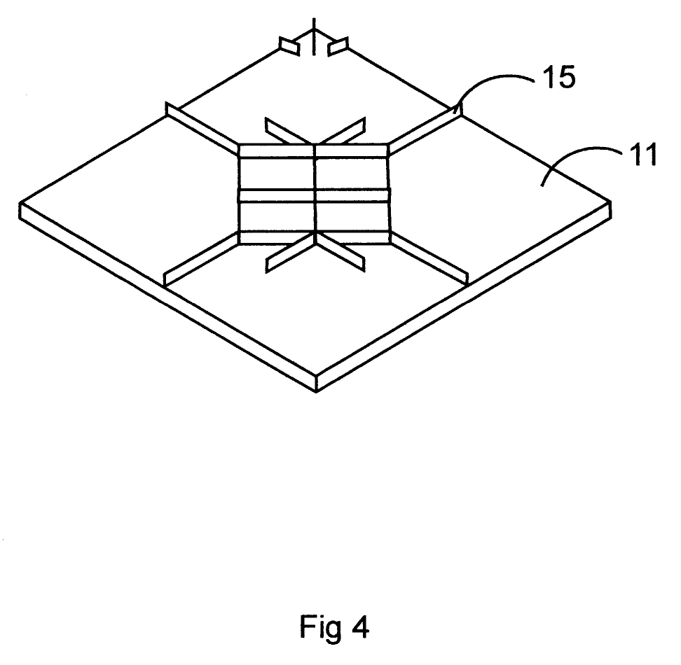

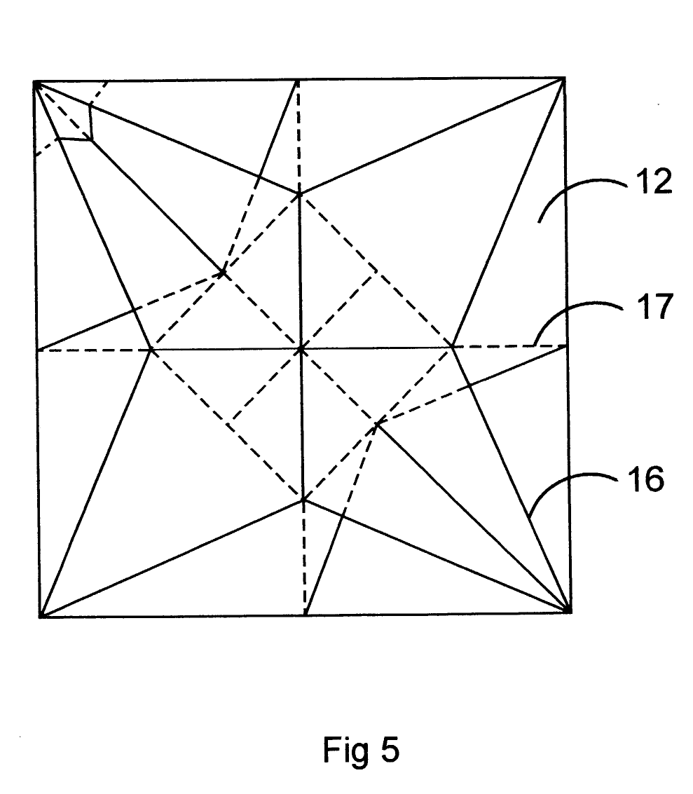

FIG. 3 and 4 are example dies 10 needed to create the scores 15 on the flexible material 12 to create FIG. 2. Each die base can be any shape or size and able to hold scorers 15. Each scorer 15 can be any shape, size and made out of any material able to score. Each die base 11 can contain any amount of scorers 15 and each scorer 15 can be placed in any position on the die base 11.

FIG. 5 shows where each scorer 15 should be position to create example in FIG. 2. Solid lines represent valley folds 16 excluding the perimeter solid lines and the dashes represent the mountain folds 17.

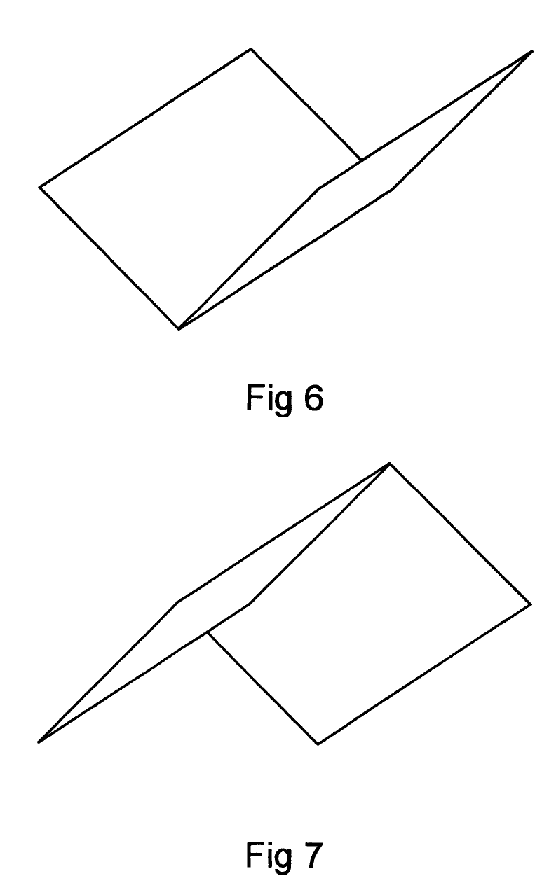

FIG. 6 is an example of folded flexible material 12 in a valley fold position.

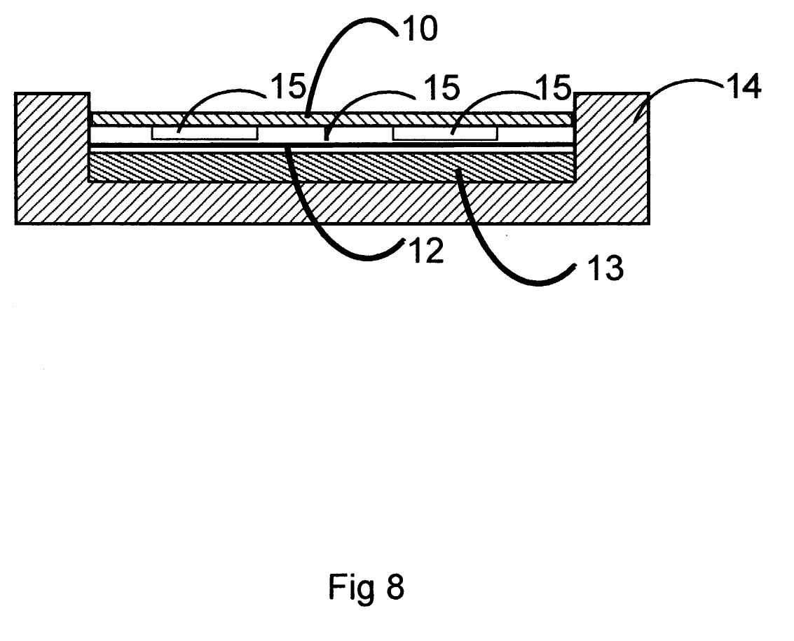

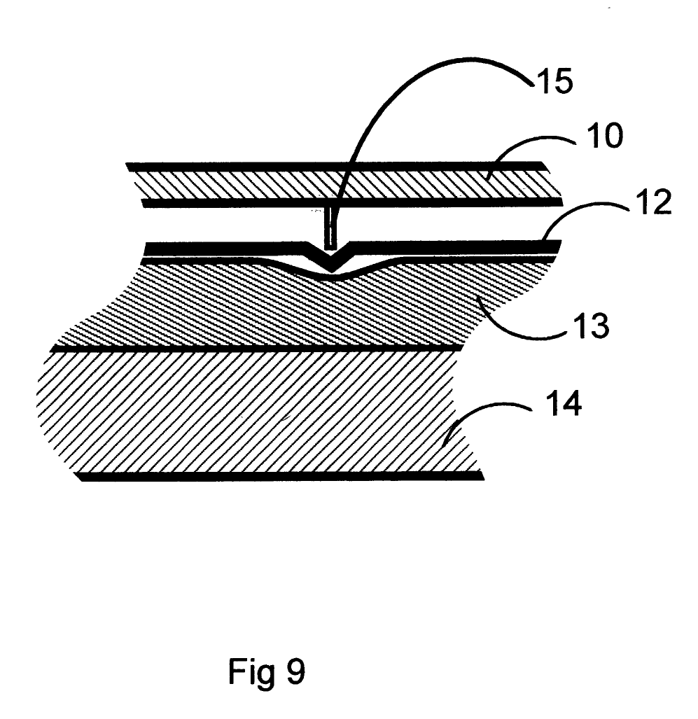

FIG. 7 is an example of folded flexible material 12 in a valley fold position.

### Operation

The drawings illustrate a dies(s) 10 and a main base 14 is used to carry out the teachings of the invention. Depending on the object you want to create the number of dies 10 may vary. The main base 14 can be made out of any material and of any shape or size. The recess part 18 of the base is to be a same size and shape as the die 10. Inside the recess part 18 lies a soft material 13. This soft material 13 is for when the scorers 15 press against the flexible material 12. They allow the material 12 to sink in but not tear through the flexible material 12 thus scoring it to specifications.

The die 10 is made up of a main base 14 which can be made out of any material and the same shape and size as the recessed part 18 of the main base 14 and have scorers 15 which can be any shaper or size and material able to score the flexible material 12. Each scorer 15 can be placed on the die base 11 in any position needed to score.

Each die 10 will be used to score the flexible material 12 into either valley folds 16 or mountain folds 17. The terms valley folds 16 and the mountain folds 17 used in origami or paper folding.

To us the invention one places a flexible material 12 in the recessed part 18 of the die base 14. Then with the use of hands or machine, place the die 10 over the flexible 12 and press on the flexible material 12 with enough pressure to score the material. This will score the material 12 to create either the mountain folds 17 or valley folds 16.

Next remove the die 10 and take out the flexible material 12 and flip it over and place it back in the recessed part 18 and use another die 10 to complete the process to score the flexible material 12 to create the opposite folds.

When finished the scores on the flexible material 12 will look like FIG. 5.

Then with the use of hands, one manipulates the paper to create the object in FIG. 2.

I claim

1. A paper scoring system comprising of a die base and one or more dies.

2. The paper scorer of claim 1 wherein said die base is shaped to receive die or dies.

3. The paper scorer of claim 2 wherein said die base contains a soft material in die base recess.

4. The paper scorer of claim 3 wherein said soft material in die base is depending on material scored.

5. The paper scorer of claim 1 wherein said die is shaped to fit die base.

6. The paper score of claim 1 wherein said die contains scorers.

7. The paper scorer of claim 5 wherein said scorers are in numerous positions.

8. The paper scorer of claim 5 wherein said scorer are of equal height.

9. The paper scorer of claim 5 wherein said scorers scoring edge are shaped according to the material used.
